(19) United States
(12) Patent Application Publication
(10) Pub. No.: US 2004/0098289 A1
(43) Pub. Date: May 20, 2004

(54) Operations management policy distributing method, operations management policy distributing apparatus, and operations management policy distributing program

(75) Inventor: Hideo Sugimori, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/690,584

(22) Filed: Oct. 23, 2003

(30) Foreign Application Priority Data
Oct. 23, 2002 (JP) 2002-308389

(51) Int. Cl. G06F 17/60

(52) U.S. Cl. 705/7

(57) ABSTRACT

An operations management policy distributing method, an operations management policy distributing apparatus, and an operations management policy distributing program, which distributes an operations management policy suited to an inventory of a system to be managed, and also presents an index indicating their usefulness, thereby greatly reducing the work required in system operations management

### BACKGROUND OF THE INVENTION

1. Field of the Invention

The present invention relates to a technique for greatly reducing the work required in system operations management when performing operations management for computer network systems.

2. Description of the Related Art

Sometimes, operations management software is implemented in computer network systems such as LANs (Local Area Networks) with an object of centrally managing clients, as disclosed in Japanese Unexamined Patent Publication No. 2001-222424 or Japanese Unexamined Patent Publication No. 2001-306611. In system operations management according to the operations management software, if some abnormality occurs in the hardware or applications in tho system to be managed, an operations management server is notified of the occurrence of abnormality. Therefore, in the system operations management, in order to notify only abnormal events required by the operations management server, an operations management policy (referred to simply as a “policy” below), which defines filtering or an operations management method of the system to be managed, is essential. At this time, if the policy is inappropriate, there is a possibility that required abnormal events are not notified, or when a large number of unnecessary anomalous events are notified, actually required abnormal events are lost. Furthermore, after the system operations management has been started, if hardware or applications are either added or upgraded in the system to be managed, then the policy must be updated as needed. However, the policy can be defined only based on the presence of detailed information for the system to be managed and system operation management experience. Therefore, the definition and update of policy has not been easy.

Consequently, there has been proposed a technique for distributing a policy required for system operations management to an operations management server via a computer network such as the Internet. However, even with such a technique, the system manager is required to select a policy from amongst various policies based on his or her own judgment, and it is therefore difficult to select a policy suited to the system to be managed. Furthermore, the policy distributed to the operations management server is not necessarily the most suitable policy, and whether or not the policy is the most suitable can be judged only after the system operations management has been actually started.

Therefore, in accordance with the above problems, an object of the present invention is to provide a technique for distributing operations management policy which distributes an operations management policy suited to an inventory of a system to be managed, and also presents an index indicating the usefulness thereof, thereby greatly reducing the work required in system operations management.

### SUMMARY OF THE INVENTION

In order to achieve the above object, in a technique for distributing an operations management policy according to the present invention, when inventory information specifying an inventory of a system to be managed is received, a database storing operations management policies corresponding to various inventories is retrieved, and a policy list detailing operations management policies suited to the inventories specified by the inventory information, is created to be transmitted. Then, upon receiving selection information indicating the selection of at least one operations management policy from the policy list, the database is retrieved, and the operations management policy specified by the selection information is acquired to be transmitted.

According to this construction, since the policy list detailing operations management policies suited to the inventories of the system to be managed is distributed, a system administrator needs only select a required operations management policy from that list. As a result the selected operations management policy is distributed, and the policy is applied to the system to be managed. Therefore, thre is no need for the system administrator to define the operations management policy, or to select the operations management policy, which he or she considers suitable for the system to be managed from a vast operations management policies, thereby enabling to greatly reduce the work in system operations management.

At this time, it is desirable that inventory information is stored appropriately in a database, and when the inventory information is received, a policy list suited to the inventory specified by a difference between the received inventory information and the stored inventory information is created. Thus, only a policy list corresponding to the difference is distributed, which reduces the number of operations management policies to be selected, further reducing the work required for selection.

Furthermore, it is desirable that usage frequencies of the operations management policies applied to the system to be managed are also stored appropriately in a database, and the usage frequencies stored in the database are appended to each of the operations management policies detailed in the policy list. At this time, it is desirable to use, as the usage frequency, the number of references, the operating time and the number of applications of each of the operations management policies applied to system to be managed. Furthermore, it is desirable to sort the policy list in descending order using one selected arbitrarily from the number of references, the operating time and the number of applications, as a key.

According to this construction, it is possible to ascertain the usefulness of an operations management policy via, its usage frequency, that is, its past usage, and it is therefore possible even for a user with a lack of experience in managing the system to easily select an operations management policy from the policy list. Furthermore, by using, as the usage frequency, the number of references, the operating time and the number of applications, based on specific figures thereof, it is possible to ascertain the usefulness of an operations management policy. In addition, if the policy list is sorted in descending order using one selected arbitrarily from the number of references, the operating time and the number of applications as the key, a difference in usefulness can be easily ascertained since the list is ordered from the most useful policy down to the least useful policy.

Moreover, the construction may be such that, when the inventory information is received, the database is retrieved, and an operations management policy suited to the inventory specified by the inventory information is acquired and transmitted. Thus, the operation of selecting an operations management policy from a policy list becomes unnecessary, allowing operations management polices to be distributed automatically.

At this time, it is desirable to set for each operations management policy whether or not the deletion is allowable, and that those operations management policies set as non-deletable policies are necessarily acquired regardless of their usage frequency. Thus, actually required operations management policies are necessarily distributed regardless or their usage frequency.

Other objects and aspects of this invention will become apparent from the following descriptions of the embodiments with reference to the appended drawings.

### BRIEF DESCRIPTION OF THE DRAWINGS

FIG. 1 is structural diagram of the entire structure for distributing a policy to an operations management server, using a policy distributing server according to the present invention.

FIG. 2 is an explanatory diagram schematically showing functions of the structure.

FIG. 3 is an explanatory diagram showing a user information storage DB.

FIG. 4 is an explanatory diagram showing an inventory information storage DB.

FIG. 5 is an explanatory diagram showing specific examples of policies, wherein (A) to (E) are an event monitoring policy, a process monitoring policy, an MIB monitoring policy, a TRAP monitoring policy and a network monitoring policy, respectively.

FIG, 6 is an explanatory diagram showing a usage frequency information storage DB.

FIG. 7 is an explanatory diagram schematically showing a process for distributing a policy list.

FIG. 8 is an explanatory diagram of the policy list.

FIG. 9 is an explanatory diagram of a policy list screen.

FIG. 10 is an explanatory diagram of a policy details screen.

FIG. 11 is an explanatory diagram schematically showing a process for applying a policy.

FIG. 12 is a flowchart showing the policy distributing process in tho policy distributing server.

FIG. 13 is a flowchart showing the policy distributing process in an operations management server.

FIG. 14 is an explanatory diagram schematically showing a process for gathering usage frequency information.

FIG. 15 is a flowchart showing the usage frequency information gathering process in a client.

FIG. 16 is a flow chart showing the usage frequency information gathering process in the operations management server.

FIG. 17 is a flow chart showing the usage frequency information gathering process in the policy distributing server.

### DETAILED DESCRIPTION OF THE INVENTION

The present invention will be described in detail below with reference to the appended drawings.

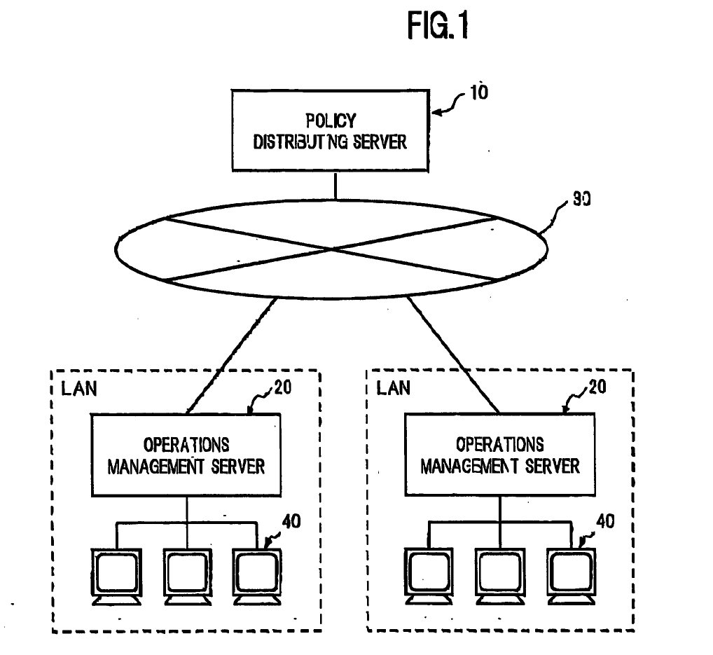

FIG. 1 is a diagram showing the entire structure for distributing a policy to each operations management server 20 managing a LAN, using a policy distributing server 10 according to the present invention. Here, the policy distributing server 10 and the operations management server 20 are each constructed from a general purpose computer system comprising a processor, a memory and a communication apparatus, and are interconnected via the Internet 30. Furthermore, a management agent monitoring abnormal event based on the policy is integrated into each client 40 of the LAN, being a system to be managed.

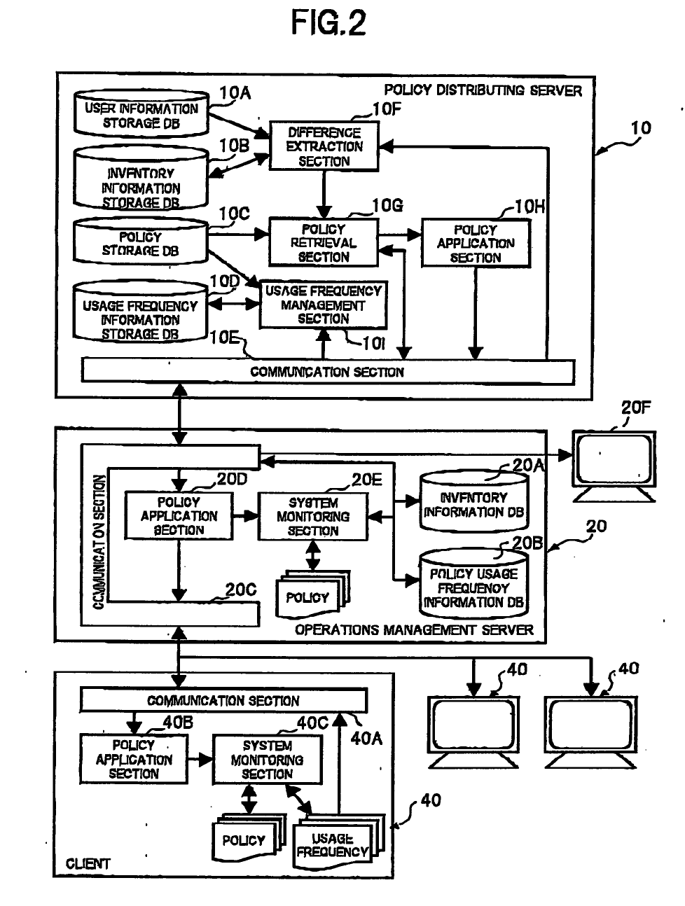

FIG. 2 shows schematically functions provided in the policy distributing server 10, the operations management server 20 and the client 40, respectively.

The policy distributing server 10 comprises, as various databases (DB), a user information storage DB 10A, an inventory information storage DB 10B, a policy storage DB 10C, and a usage frequency information storage DB 10D.

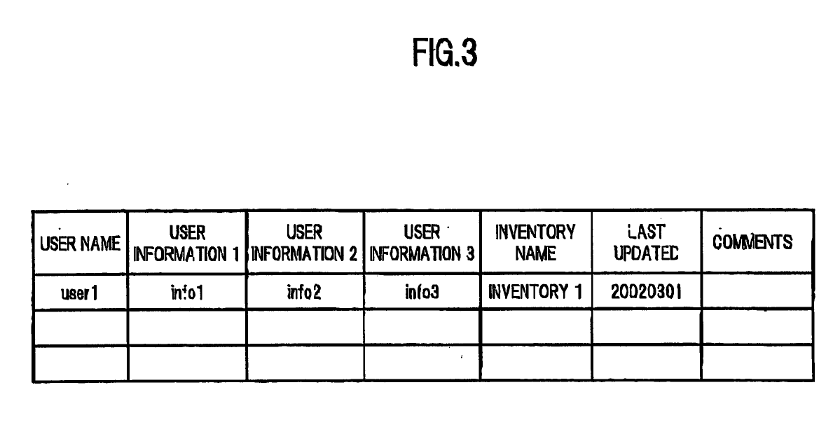

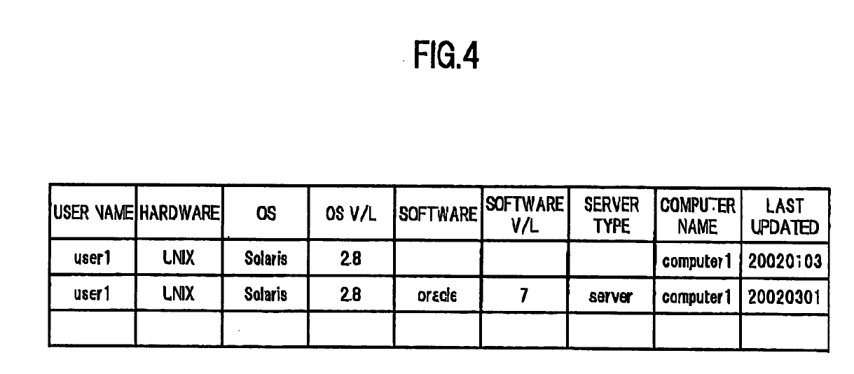

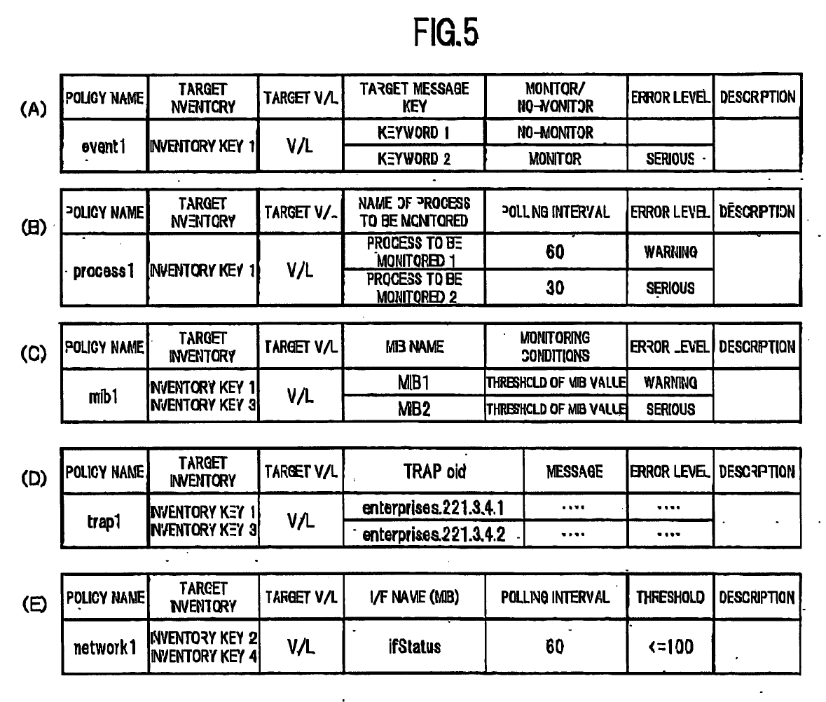

As shown in FIG. 3, the user information storage DB 10A stores user information 1 to 3 which holds user names, user IDs and passwords and the like, inventory names for uniquely specifying inventory information for the users, dates last updated, comments and the like, in order to serve to user authentication by the policy distributing server 10. Here, the inventory information is information specifying various resources of the client 40 (inventory=hardware, software and the like). As shown in FIG. 4, the inventory information storage DB 10B stores user names, hardware, OS (Operating System), OS version and level (V/L), software, software version and level, server type, computer names which uniquely specify clients, dates last updated and the like, so to enable the inventory of the client 40 to be specified. The policy storage DB 10C stores policies corresponding to various inventories, and information for their application. Here, the policies include, for example, an event monitoring policy, a process monitoring policy, an MIB (Management Information Base) monitoring policy, a TRAP monitoring policy, a network monitoring policy and the like, as shown respectively in (A) to (E) of FIG. 5. Each policy comprises a unique policy name, a target inventory, a target version and level, entries corresponding to a monitoring target (a target message key and the like), and a description. As shown in FIG. 6, the usage frequency information storage DB 10D stores policy names, the number of references, the operating time, the number of applications showing the application histories of the policies and the like, so that the usage frequencies of policies can be managed collectively.

Furthermore, in the policy distributing server 10, a communication section 10E, a difference extraction section 10F, a policy retrieval section 10G, a policy application section 10H and a usage frequency management section 10I are each realized by a program loaded into the memory. The communication section 10E provides a function for connecting the policy distributing server 10 to the internet 30 via the communication apparatus, to exchange various data with the operations management server 20. The difference extraction section 10F provides a function for creating difference information by extracting A difference between the inventory information received from the operations management server 20 and the inventory information stored in the inventory information storage DB 10B. The policy retrieval section 10G provides a function for retrieving the policy storage DB 10C and the usage frequency information storage DB 10D based on the difference information or selection information (to be described in detail below), to acquire a policy suited to the difference information or the selection information. The policy application section 10H provides a function for transmitting the policy acquired by the policy retrieval section 10G to me operations management server 20 via the communication section 10E. The usage frequency management section 10I provides a function for managing the usage frequency of each policy (number of references, operating time and number of applications), in cooperative with the usage frequency information storage DB 10D.

On the other hand, the operations management server 20 comprises, as the various databases, an inventory information DB 20A and a policy usage frequency information DB 20B. The latest inventory information in each client 40 is stored in the inventory information DB 20A. Moreover, usage frequency information for each policy in the LAN is stored in the policy usage frequency information DB 20B.

Furthermore, in the operations management server 20, a communication section 20C, a policy application section 20D and a system monitoring section 20E are each realized by a program loaded into the memory. The communication section 20C provides a function for connecting the operations management server 20 to the Internet 30 or the LAN via the communication apparatus, to exchange various data with the policy distributing server 10 or the client 40. In addition, the communication section 20C also provides a function for connecting to a console 20I used to operate the operations management server 20. The policy application section 20D provides a function for applying the policy received from the policy distributing server 10 and transmitting the policy to the client 40 via the communication section 20C. Tho system monitoring section 20E provides a function for monitoring the applied policy, the inventory information DB 20A and the policy usage frequency information DB 20B.

In the client 40, a communication section 40A, a policy application section 40B and a system monitoring section 40C are each realized by a program (management agent) loaded into the memory. The communication section 40A provides a function for connecting the client 40 to the LAN via the communication apparatus, to exchange various data with the operations management server 20. The policy application section 40B provides a function for applying the policy received from the operations management server 20. The system monitoring section 40C provides a function for monitoring the applied policy and managing the usage frequency of the policy.

Next, a series of processing for distributing a policy to the operations management server 20 using the policy distributing server 10 of the above construction will be described.

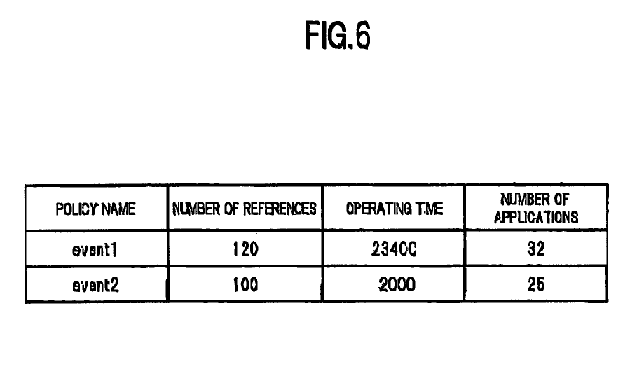

FIG. 7 shows schematically the processing performed until a list of policies suited to the inventory of the client 40 (hereafter referred to as a policy list) is distributed to the operations management server 20 from the policy distributing server 10.

Once the operations management carver 20 is connected to the policy distributing server 10, inventory information 50 stored in the inventory information DB 20A is transmitted to the policy distributing server 10 via the communication section 20C. Here, the newest inventory information for each client 40 is stored in the inventory information DB 20A, based on the inventory information appropriately transmitted from the management agent of each client 40.

In the policy distributing server 10, the received inventory information 50 is transmitted to the difference extraction section 10F via the communication section 10E. In the difference extraction section 10F, by referring to the user information storage DB 10A, the inventory information suited to the operations management server 20 is specified using the inventory name, and this inventory information is acquired from the inventory information storage DB 10B. Furthermore, a difference between the newest inventory information and the stored inventory information is extracted, and difference information 52 indicating the difference between the two is created. Here, when there is difference between the newest inventory information and the stored inventory information, the inventory information storage DB 10B is appropriately updated based on the newest inventory information. A step of appropriately storing the inventory information in the database is realized by this processing for appropriately updating the inventory information storage DB 10B.

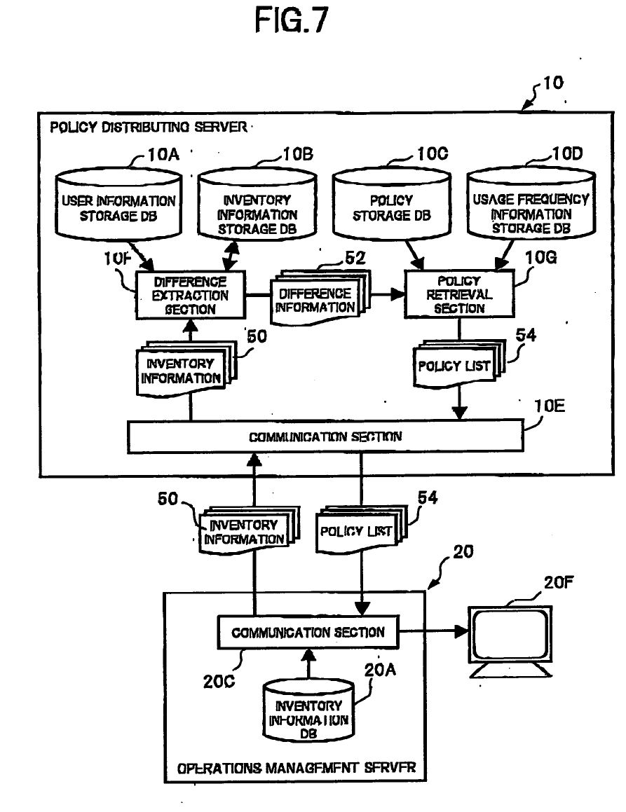

The difference information 52 created by the difference extraction section 10F is transmitted to the policy retrieval section 10G. In the policy retrieval section 10G, the policies suited to the difference information 52 are acquired from the policy storage DB 10C, and a policy list 54 detailing these policies is created. Furthermore, in the policy retrieval section 10G, usage frequency information for the policies is acquired from the usage frequency information storage DB 10D, and the usage frequency information is appended to each policy detailed in the policy list 54. Furthermore, using the usage frequency as a key, the policy list 54 is sorted in descending order, as shown in FIG. 8. Here, the usage frequency used as the key may be calculated from the number at references, the operating time and the number of applications using known statistical techniques, or may be selected arbitrarily from the number of references, the operating time or the number of applications, for example. Subsequently, the policy list 54 is transmitted to the operations management server 20 via the communication section 10E.

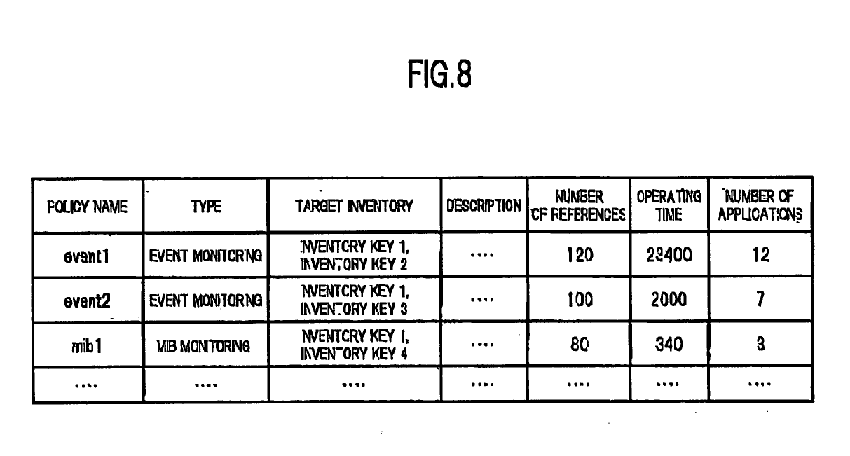

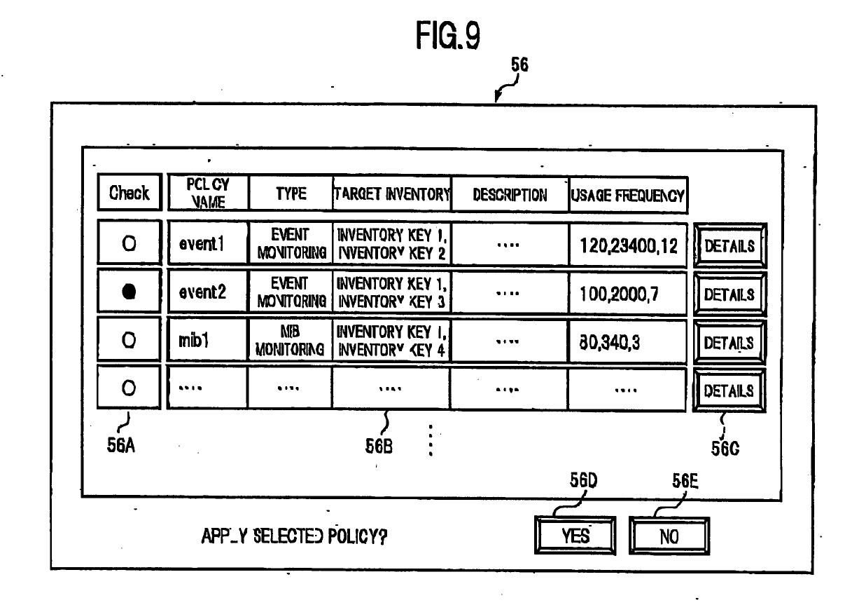

In the operations management server 20, once the policy list 54 is received, a policy list screen 56 as shown in FIG. 9 is displayed on the console 20F using the function provided by the communication section 20C. The policy list screen 56 comprises; a selection section 58A selecting a policy to be adopted; a policy display section 56B displaying the type, target inventory, description and usage frequency corresponding to each policy name; a “Details” button 56C checking details of the policies; a “Yes” button 56D; and a “No” button 56E. When the “Details” button 56C is clicked, a policy details screen 58 as shown in FIG. 10 is displayed.

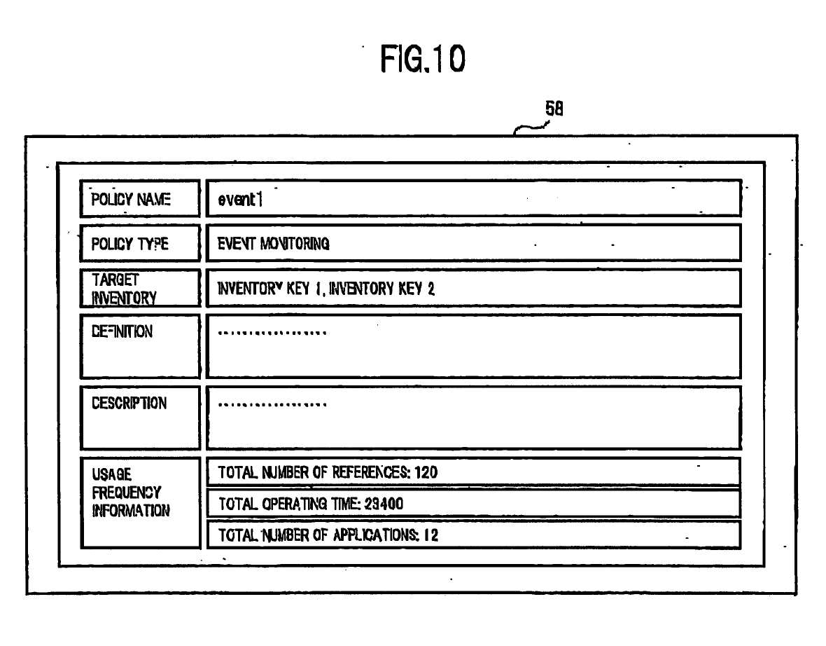

FIG. 11 shows schematically the processing performed from when the policy list is displayed on the console 20F of the operations management server 20 until a policy is distributed from the policy distributing server 10 to be applied to the client 40.

In the policy list screen 56, after a user has selected at least one policy which he or she wishes to adopt using the selection section 56A, if the “Yes” button 56D is clicked, selection information 60 is transmitted to the policy distributing server 10 via the communication section 20C. At this time, since the usage frequency information for each policy is also displayed on the policy list screen 56 or the policy details screen 58, the usefulness of each policy can be determined from the usage frequency information. As a result, the user of the policy distributing server 10 can easily select the optimum policy by referring to the usefulness of the policy, even if he or she has limited system operations management experience, thereby enabling to greatly reduce the work required for system operations management.

On the other hand, in the policy distributing server 10, the received selection information 60 is transmitted to the policy retrieval section 10G via the communication section 10E. In the policy retrieval section 10G, a policy 62 suited to the selection information 60 is acquired from the policy storage DB 10C, to be transmitted to the policy application section 10H. In the policy application section 10H, the policy 62 is transmitted to the operations management server 20 via the communication section 10E.

In the operations management server 20, the received policy 62 is transmitted to the policy application section 20D via the communication section 20C. In the policy application section 20D, the policy 62 is applied to the operations management server 20 by the function provided by the system monitoring section 20E, and the policy 62 is also transmitted to the client 40 via the communication section 20C.

In the client 40, the received policy 62 is transmitted to the policy application section 40B via the communication section 40A. In the policy application section 40B, once the policy 62 has been applied to the client 40 by the function provided by the system monitoring section 40C, monitoring for abnormal events is started based on the policy 62.

Such a policy distributing processing is realized in the following manner.

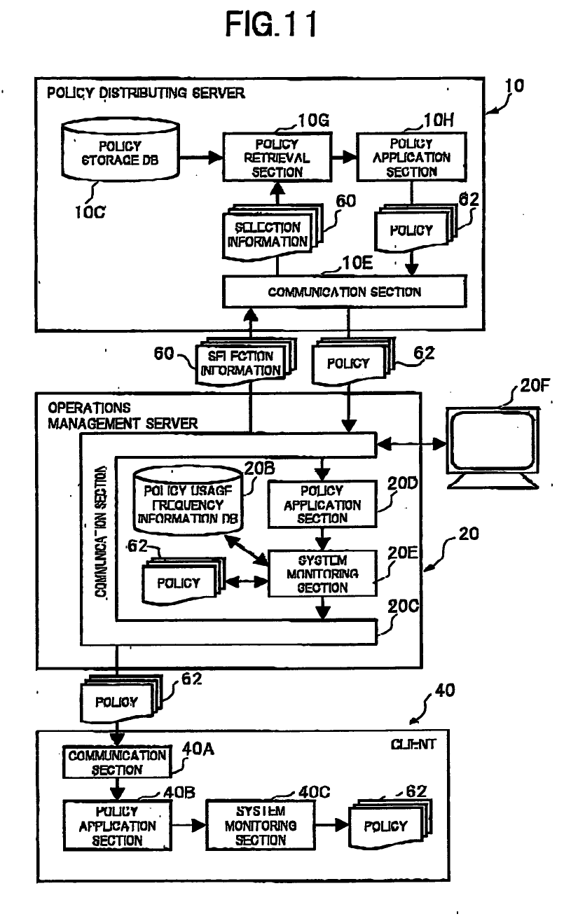

FIG. 12 shows the contents of the processing executed in the policy distributing server 10 when a connection request is received from the operations management server 20.

In step 1 (abbreviated to S1 in the drawings, with others abbreviated in the same manner), a determination is made as to whether or not a user who issued the connection request is authorized, that is, whether or not the user is registered in the user information storage DB 10A. This determination as to whether or not the user is registered in the user information storage DB 10A can be made, by retrieving the user information storage DB 10A using the user ID and password included in the connection request as retrieval keys to ascertain whether or not the user can be identified. If the user is authorized, control proceeds to step 3 (Yes). On the other hand, if the user is not authorized control proceeds to step 2 (No), where user registration requiring the user to enter his or her particulars is carried out in order to make the user as a registered user of the policy distributing server 10.

In step 3, a request for the transmission of inventory information is transmitted to the operations management server 20.

In step 4, the inventory information is received from the operations management server 20.

In step 5, a determination is made as to whether or not inventory information for the user is already stored in the inventory information storage DB 10B, that is, whether or not the user has previously used the policy distributing server 10. If this inventory information is already stored, control proceeds to step 6 (Yes), whereas if this inventory information is not stored, control proceeds to step H (No).

In step 6, the user information storage DB 10A and the inventory information storage DB 10B are retrieved using the user name as a retrieval key, and the inventory information stored for the user is acquired.

In step 7, a difference between the received inventory information and the stored inventory information is extracted, and difference information indicating the difference between the two is created.

Note, a step of extracting the difference is realized by a series of processing in steps 5 through 7.

In step 8, the policy storage DB 10C is retrieved using the difference information as a retrieval key, and policies suited to the inventory specified by the difference information are acquired. Here, if the inventory information for the user is not stored, than policies are acquired using the complete inventory information as a difference. Then, based on the acquired policies, a policy list detailing these policies is then created.

A step of creating the policy list, list creation means and a list creation function are all realized by as series of processing in step 4 and step 8.

In step 9, the usage frequency information storage DB 10D is retrieved using the policy name as a retrieval key, and the usage frequency (the number of references, the operating time and the number of applications) for each policy is appended to the policy list. A step of appending the usage frequency is realized by the processing in step 9.

In step 10, the policy list is sorted in descending order of usage frequency.

In step 11, the policy list is transmitted to the operations management server 20. A step of transmitting the policy list, list transmission means and a list transmission function are all realized by the processing in step 11.

In step 17, the selection information is received from the operations management server 20.

In step 13, the policy storage DB 10C is retrieved using the selection information as a retrieval key, and the policy specified by the selection information is acquired.

A step of acquiring the operations management policies, policy acquiring means and a policy acquiring function are all realized by a series of processing in step 12 and step 13.

In step 14, the acquired policy is transmitted to the operations management server 20. A step of transmitting tie operations management policy, policy transmission means and a policy transmission function are all realized by the processing in step 14.

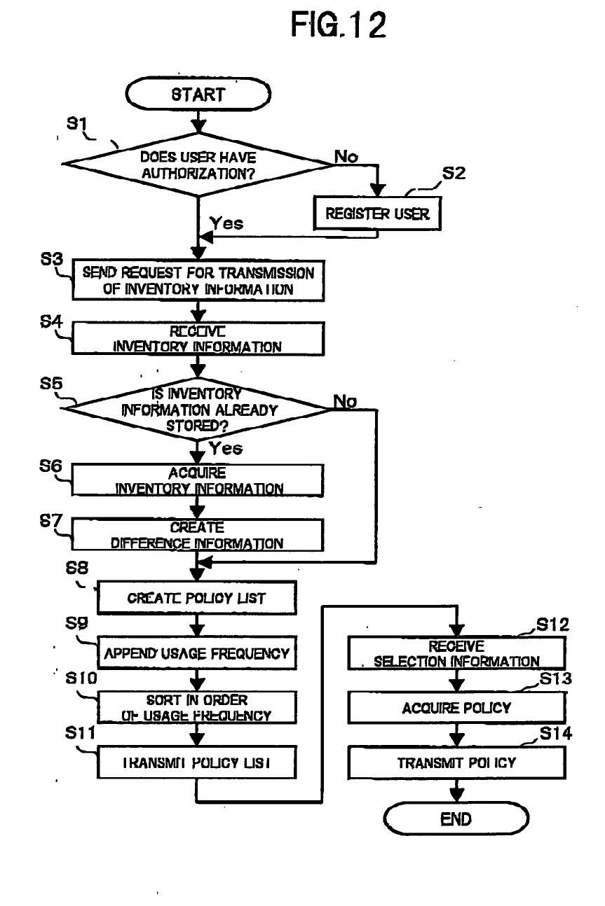

FIG. 13 shows the contents of the processing executed in the operations management server 20 when an inventory information transmission request, a policy list or a policy is received from the policy distributing server 10.

In step 21, a branch processing is performed according to the content received. In other words, if the content received is an inventory information transmission request, control proceeds to step 22, if the content received is a policy list, control proceeds to step 23, and if the content received is a policy, control proceeds to step 26.

In step 22, the inventory information stared in the inventory information DB 20A is transmitted to the policy distributing server 10. At this time, the usage frequency information stored in the policy usage frequency information DB 20B is also transmitted together with me inventory information.

In step 23, the policy list screen 56 is displayed on the console 20F.

In step 24, at least one policy, is selected from the policies detailed in the policy list screen 56 via the console 20F.

In step 25, selection information is created from the selected policy, to be transmitted to the policy distributing server 10.

In step 26, the policy is applied to the operations management server 20 and the client 40. At this time, since it is necessary to specify an application target when applying the policy to the client 40, this process is executed according to the operational content of the console 20F.

In step 27, the usage frequency information stored in the policy use frequency information DB 20B is updated, in order to update the number of applications of the policy.

According to the processing in FIG. 12 and FIG. 13, the policy list suited to the inventory of the client 40 which make up the LAN is distributed to the operations management server 20 from the policy distributing server 10. Once the policy to be applied is selected, using the usage frequency information for each policy appended to the policy list as an index to indicate the usefulness of policy, the policy is distributed to the operations management server 20. Consequently, when performing the system operations management, the user does not need to select a policy suited to the system to be managed from amongst a wide variety of policies, and the work required in the operations management can be greatly reduced.

Furthermore, if the policy suited to the inventory of the client 40 is acquired directly, then the operation of selecting at least one policy from the policy list is rendered unnecessary, and policy distribution can be performed automatically. At this time, the construction may be such that thresholds are set for the number of references, the operating time and the number of applications included in the usage frequency information, and only those policies exceeding the thresholds are applied. Here, if the policy is selected automatically according to the usage frequency information, there is a possibility that the actually require policy may not be selected. Consequently, it is desirable that a flag indicating whether the policy is deletable or non-deletable is provided, and those policies flagged as non-deletable are necessarily selected regardless of their usage frequency.

A step of acquiring an operations management policy, policy acquiring means and a policy acquiring function ere all realized by this processing for directly acquiring policies. Furthermore, a step of setting as to whether the policy is deletable or non-deletable is realized by the processing for providing the flag indicating whether the policy is deletable or non-deletable.

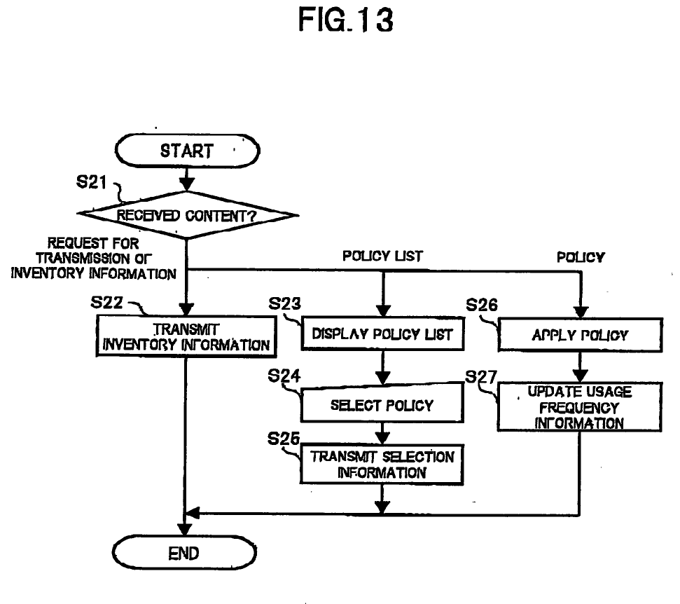

FIG. 14 shows schematically the processing for gathering use frequency information.

In the client 40, when it is detected by the system monitoring section 40C that the reference of the policy 62 has been started or completed, the usage frequency information (the number of references and the operating time) 64 at the policy 62 is updated. Each time a predetermined period of time has elapsed, the use frequency information 64 is transmitted to the operations management server 20 via the communication section 40A.

The operations management server 20, the received usage frequency information 64 is transmitted to the system monitoring section 20E via the communication section 20C, in the system monitoring section 20E, the usage frequency information stored in the policy usage frequency information DB 20B is updated based on the received usage frequency information 64, and the usage frequency information about the policies in the LAN is aggregated collectively. When the operations management server 20 is connected to the policy distributing server 10, the usage frequency information 64 stored in the policy usage frequency information DB 20B is transmitted to the policy distributing server 10 via the communication section 20C.

In the policy distributing server 10, the received usage frequency information 64 is transmitted to tho usage frequency management section 101 via the communication section 10E. In the usage frequency management section 10I, the usage frequency information stored in the usage frequency information storage DB 10D is updated based on the received usage frequency information 64, and the application information for the policies stored in the policy storage DB 10C is updated.

Such processing of usage frequency information gathering at the present invention is realized in the following manner.

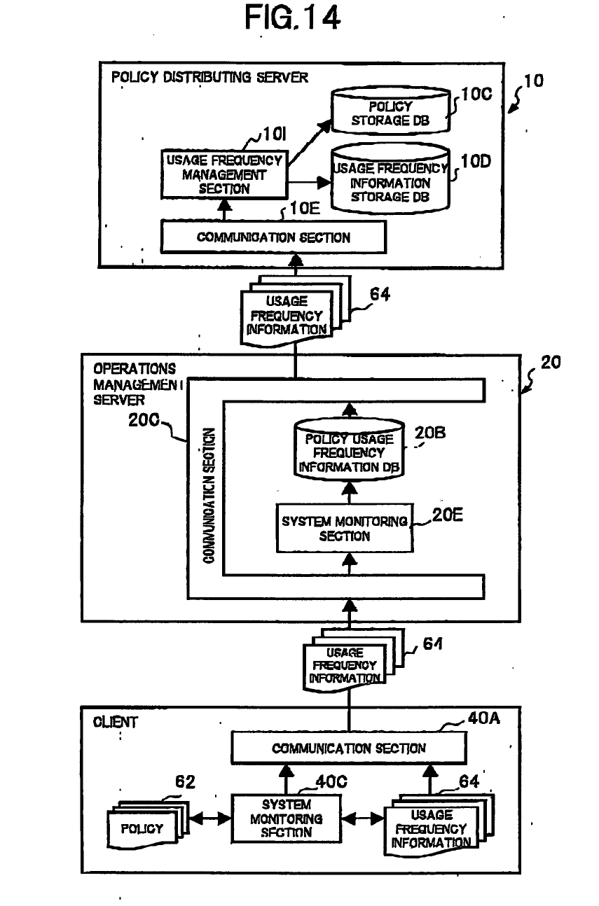

FIG. 15 shows the contents of the processing executed in the client 40 when the policy is applied.

In step 31, initializing processing is executed. In other words, a timer measuring the operating time of the policy is reset, and also the usage frequency information is cleared.

In step 32, a determination is made as to whether or not the reference of policy has been started. If the reference of policy has been started, then control proceeds to step 33 (Yes), whereas if the reference of policy has not been started, control enters a standby state (No).

In step 33, the timer is stared in order to start measuring of the operating time of the policy.

In step 34, the number of references in the usage frequency information is incremented.

In step 35, a determination is made as to whether or not the reference of policy has been completer, and if the reference of policy has been completed, control proceeds to step 36 (Yes), whereas if the reference of policy has not yet been completed, control enters a standby state (No).

In step 36 the operating time in the usage frequency information is updated based on an elapsed time measured by the timer.

In step 37, the timer is reset in preparation for measuring of the next time operating time.

In step 38, a determination is made as to whether or not it is time to transmit the usage frequency information, that is, whether or not a predetermined period of time has elapsed since the previous transmission. If it is time to transmit the usage frequency information, control proceeds to step 39 (yes), whereas if it is not yet time to transmit the usage frequency information, control returns to step 32 (No).

In step 39, the usage frequency information is transmitted to the operations management server 20. Subsequently, control returns to step 31.

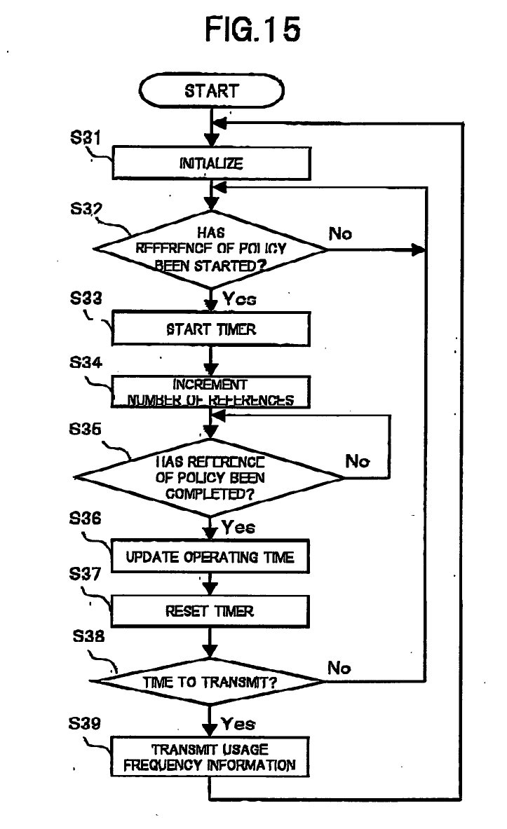

FIG. 16 shows the contents of the processing executed in the operations management server 20 upon receiving the usage frequency information from the client 40.

In step 41, the usage frequency information stored in the policy usage frequency information DB 20B is updated based on the received usage frequency information.

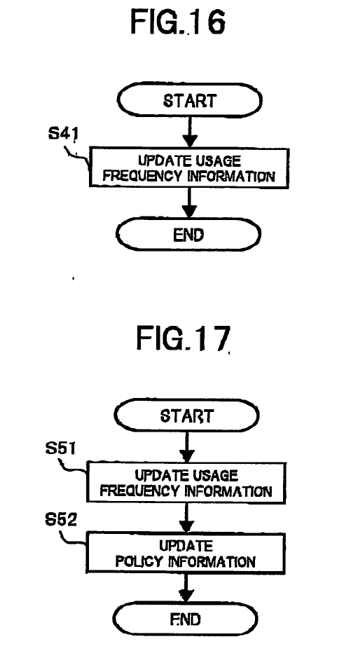

FIG. 17 shows the contents of the processing executed in the policy distributing server 10 upon receiving the usage frequency information from the operations management server 20.

In stop 51, the usage frequency information stored in the usage frequency information storage DB 10D is updated based on the received usage frequency information. A step of appropriately storing usage frequency information in the database is realized by the processing in step 51.

In step 52, the application information for the policies stored in the policy storage DB 10C is updated based on the received usage frequency information.

According to the processing in FIG. 15 through FIG. 17, the usage frequencies of the policies in each client 40 are collectively aggregated in the operations management server 20. Then, when the operations management server 20 is connected to the policy distributing server 10, the usage frequency information collectively aggregated in the operations management server 20 is transmitted to the policy distributing server 10. In the policy distributing server 10, the usage frequencies of the policies in each operations management server 20 are collectively aggregated based on the received usage frequency information. As a result, the usage frequency information stored in the usage frequency information storage DB 10D is updated appropriately, and by displaying this updated information together with the policy list, an index indicating the usefulness of a policy can be provided to the user.

What is claimed is:

1. An operations management policy distributing method, comprising the steps which are executed in sequence of:
upon receiving inventory information specifying an inventory of a system to be managed, retrieving a database storing operations management policies corresponding to various inventories and creating a policy list detailing operations management policies suited to the inventories specified by said inventory information;
transmitting the created policy list;
upon receiving selection information indicating the selection of at least one operations management policy from said policy list, retrieving said database and acquiring the operations management policy specified by said selection information; and
transmitting the acquired operations management policy.

2. An operations management policy distributing method according to claim 1, further comprising the steps of:
appropriately storing said inventory information in a database; and
extracting a difference between said inventory information and the inventory information stored in said database when said inventory information is received,
wherein said step of creating a policy list, retrieves said database and creates a policy list suited to the inventory specified by said difference.

3. An operations management policy distributing method according to claim 1, further comprising the steps of:
appropriately storing in a database usage frequencies of the operations management policies applied to said system to be managed; and
appending the usage frequencies stored in said database to each of the operations management policies detailed in said policy list.

4. An operations management policy distributing method according to claim 3,
wherein said usage frequency comprises; the number of references, the operating time and the number of applications of each of the operations management policies applied to said system to be managed.

5. An operations management policy distributing method, comprising the steps which are executed in sequence of:
upon receiving inventory information specifying an inventory of a system to be managed, retrieving a database storing operations management policies corresponding to various inventories and during operations management policies suited to the inventories specified by said inventory information; and
transmitting the acquired operations management policy.

6. An operations management policy distributing method according to claim 5, further comprising the stop of:
setting for each operations management policy whether or not the deletion is allowable,
wherein said step of acquiring said operations management policy necessarily acquires those operations management policies set as non-deletable policies regardless of their usage frequency.

7. An operations management policy distributing apparatus, comprising:
a database storing operations management policies corresponding to various inventories;
list creating means for, upon receiving inventory information specifying an inventory of a system to be managed, retrieving said database and creating a policy list detailing operations management policies suited to the inventories specified by said inventory information;
list transmission means for transmitting the policy list created by said list creating means;
policy acquiring means for, upon receiving selection information indicating the selection of at least one operations management policy from said policy list, retrieving said database and acquiring the operations management policy specified by said selection information; and
policy transmission means for transmitting the operations management policy acquired by said policy acquiring means.

8. An operations management policy distributing apparatus, comprising:
a database storing operations management policies corresponding to various inventories;
policy acquiring means for, upon receiving inventory information specifying an inventory of a system to be managed, retrieving said database and acquiring operations management policies suited to the inventories specified by said inventory information; and
policy transmission means for transmitting the operations management policy acquired by said policy acquiring means.

9. An operations management policy distributing program, for executing on a computer:
a list creating function for, upon receiving inventory information specifying an inventory of a system to be managed, retrieving a database storing operations management policies corresponding to various inventories and creating a policy list detailing operations management policies suited to the inventories specified by said inventory information;
a list transmission function for transmitting the policy list created by said list creating function;
a policy acquiring function for, upon receiving selection information indicating the selection of at least one operations management policy from said policy list, retrieving said database and acquiring the operations management policy specified by said selection information; and
a policy transmission function for transmitting the operations management policy acquired by said policy acquiring function.

10. An operations management policy distributing program, for executing on a computer:
a policy acquiring function for, upon receiving inventory information specifying an inventory of a system to be managed, retrieving a database storing operations management policies corresponding to various inventories and acquiring a policy list detailing operations management policies suited to the inventories specified by said inventory information; and
a policy transmission function for transmitting the operations management policy acquired by said policy acquiring function.
